(19) United States
(12) Patent Application Publication
(10) Pub. No.: US 2026/0163921 A1
(43) Pub. Date: Jun. 11, 2026

(54) ADHOC LOCATION-BASED SERVICE FRAMEWORK

(71) Applicant: T-MOBILE INNOVATIONS LLC, Overland Park, KS (US)

(72) Inventors: Khurram Ahmad MIRZA, Redmond, WA (US); Madhuri Lakshmi KOTTA, Bellevue, WA (US); Karthik Chandrasekaran, Bellevue, WA (US)

(21) Appl. No.: 18/974,432

(22) Filed: Dec. 9, 2024

(51) Int. Cl. H04L 65/1045; H04L 65/1073; H04W 64/00

(52) U.S. Cl. CPC H04L 65/1045; H04L 65/1073; H04W 64/00

(57) ABSTRACT

Systems, methods, and computer-readable media provide an adhoc location-based service framework. The adhoc location-based service framework comprises an application programming interface (API) and enables a requestor (e.g., a business that provides one or more services to a user device (UE) via an application on the UE) to query a Proxy Call Session Control Function (P-CSCF) of the node. In response to the request, the adhoc location-based service framework queries the P-CSCF for information corresponding to the one or more UEs. Once the information is retrieved, the adhoc location-based service framework provides the information to the requestor.

### SUMMARY

A high-level overview of various aspects of the invention is provided here as an overview of the disclosure and to introduce a selection of concepts further described below in the detailed description. This summary is not intended to identify key features or essential features of the claimed subject matter, nor is it intended to be used as an aid in isolation to determine the scope of the claimed subject matter.

In brief and at a high level, this disclosure describes, among other things, systems, methods, and computer-readable media that provides an adhoc location-based service framework. In particular, the adhoc location-based service framework comprises an application programming interface (API) and enables a requestor (e.g., a business that provides one or more services to a user device (UE) via an application on the UE) to query a Proxy Call Session Control Function (P-CSCF) of the node. In response to the request, the adhoc location-based service framework queries the P-CSCF for information corresponding to the one or more UEs. Once the information is retrieved, the adhoc location-based service framework provides the information to the requestor.

### BRIEF DESCRIPTION OF THE DRAWINGS

FIG. 1 illustrates a diagram of an exemplary network environment in which implementations of the present disclosure may be employed;

FIG. 2 illustrates an example network environment in which implementations of the present disclosure may be employed, in accordance with aspects herein;

FIG. 3 illustrates an example of a location framework, in accordance with aspects herein;

FIG. 4 illustrates a flow diagram of an example method for providing an adhoc location-based service framework, in accordance with aspects herein; and

FIG. 4 illustrates an exemplary computing device for use with the present disclosure.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Throughout this disclosure, several acronyms and shorthand notations are employed to aid the understanding of certain concepts pertaining to the associated system and services. These acronyms and shorthand notations are intended to help provide an easy methodology of communicating the ideas expressed herein and are not meant to limit the scope of embodiments described in the present disclosure. The following is a list of these acronyms:

| | |
|---|---|
| 3G | Third-Generation Wireless Technology |
| 4G | Fourth-Generation Cellular Communication |
| | System |
| 5G | Fifth-Generation Cellular Communication System |
| 6G | Sixth-Generation Cellular Communication System |
| AI | Artificial Intelligence |
| CD-ROM | Compact Disk Read Only Memory |
| CDMA | Code Division Multiple Access |
| eNodeB | Evolved Node B |
| GIS | Geographic/Geographical/Geospatial Information |
| | System |
| gNodeB | Next Generation Node B |
| GPRS | General Packet Radio Service |
| GSM | Global System for Mobile communications |
| iDEN | Integrated Digital Enhanced Network |
| DVD | Digital Versatile Discs |
| EEPROM | Electrically Erasable Programmable Read Only |
| | Memory |
| LED | Light Emitting Diode |
| LTE | Long Term Evolution |
| MIMO | Multiple Input Multiple Output |
| MD | Mobile Device |
| ML | Machine Learning |
| PC | Personal Computer |
| PCS | Personal Communications Service |
| PDA | Personal Digital Assistant |
| PDSCH | Physical Downlink Shared Channel |
| PHICH | Physical Hybrid ARQ Indicator Channel |
| PUCCH | Physical Uplink Control Channel |
| PUSCH | Physical Uplink Shared Channel |
| RAM | Random Access Memory |
| RET | Remote Electrical Tilt |
| RF | Radio-Frequency |
| RFI | Radio-Frequency Interference |
| R/N | Relay Node |
| RNR | Reverse Noise Rise |
| ROM | Read Only Memory |
| RSRP | Reference Signal Receive Power |
| RSRQ | Reference Signal Receive Quality |
| RSSI | Received Signal Strength Indicator |
| SINR | Transmission-to-Interference-Plus-Noise Ratio |
| SNR | Transmission-to-noise ratio |
| SON | Self-Organizing Networks |
| TDMA | Time Division Multiple Access |
| TXRU | Transceiver (or Transceiver Unit) |
| UE | User Equipment |
| UMTS | Universal Mobile Telecommunications Systems |
| WCD | Wireless Communication Device (interchangeable |
| | with UE) |

Further, various technical terms are used throughout this description. An illustrative resource that fleshes out various aspects of these terms can be found in Newton's Telecom Dictionary, 32^{nd} Edition (2022).

Embodiments of the technology may take the form of, among other things: a method, system, or set of instructions embodied on one or more computer-readable media. Computer-readable media include both volatile and nonvolatile media, removable and nonremovable media, and contemplate media readable by a database, a switch, and various other network devices. By way of example, and not limitation, computer-readable media comprise media implemented in any method or technology for storing information. Examples of stored information include computer-useable instructions, data structures, program modules, and other data representations. Media examples include but are not limited to information-delivery media, RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data momentarily, temporarily, or permanently.

By way of background, a traditional telecommunications network employs a plurality of base stations (i.e., access point, node, cell sites, cell towers) to provide network coverage. The base stations are employed to broadcast and transmit transmissions to user devices of the telecommunications network. An access point may be considered to be a portion of a base station that may comprise an antenna, a radio, and/or a controller. In aspects, an access point is defined by its ability to communicate with a user equipment (UE), such as a wireless communication device (WCD), according to a single protocol (e.g., 3G, 4G, LTE, 5G, and the like); however, in other aspects, a single access point may communicate with a UE according to multiple protocols. As used herein, a base station may comprise one access point or more than one access point. Factors that can affect the telecommunications transmission include, e.g., location and size of the base stations, and frequency of the transmission, among other factors. The base stations are employed to broadcast and transmit transmissions to user devices of the telecommunications network. Traditionally, the base station establishes uplink (or downlink) transmission with a mobile handset over a single frequency that is exclusive to that particular uplink connection (e.g., an LTE connection with an eNodeB). In this regard, typically only one active uplink connection can occur per frequency. The base station may include one or more sectors served by individual transmitting/receiving components associated with the base station (e.g., antenna arrays controlled by an eNodeB). These transmitting/receiving components together form a multi-sector broadcast are for communication with mobile handsets linked to the base station.

As used herein, “base station” is one or more transmitters or receivers or a combination of transmitters and receivers, including the accessory equipment, necessary at one location for providing a service involving the transmission, emission, and/or reception of radio waves for one or more specific telecommunication purposes to a mobile station (e.g., a UE), wherein the base station is not intended to be used while in motion in the provision of the service.

The term/abbreviation UE (also referenced herein as a user device or wireless communications device (WCD)) can include any device employed by an end-user to communicate with a telecommunications network, such as a wireless telecommunications network. A UE can include a mobile device, a mobile broadband adapter, or any other communications device employed to communicate with the wireless telecommunications network.

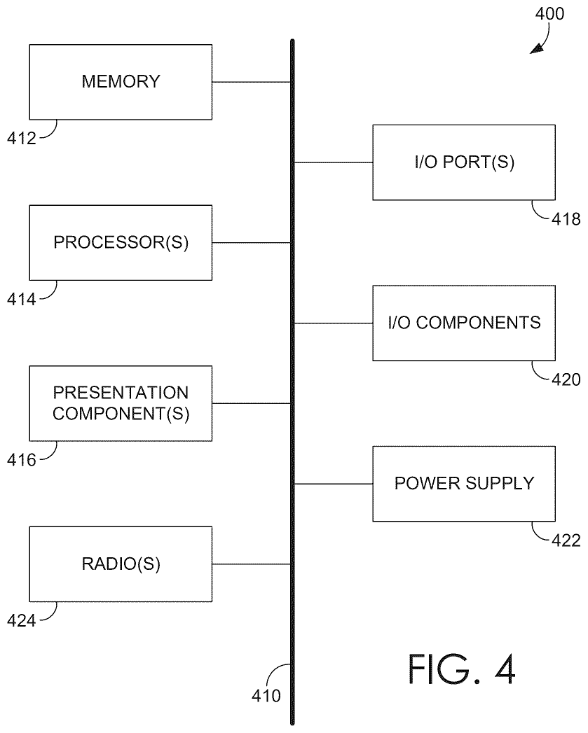

For an illustrative example, a UE can include cell phones, smartphones, tablets, laptops, small cell network devices (such as micro cell, pico cell, femto cell, or similar devices), and so forth. Further, a UE can include a sensor or set of sensors coupled with any other communications device employed to communicate with the wireless telecommunications network; such as, but not limited to, a camera, a weather sensor (such as a rain gage, pressure sensor, thermometer, hygrometer, and so on), a motion detector, or any other sensor or combination of sensors. A UE, as one of ordinary skill in the art may appreciate, generally includes one or more antennas coupled to a radio for exchanging (e.g., transmitting and receiving) transmissions with a nearby base station or access point. A UE may be, in an embodiment, similar to device 400 described herein with respect to FIG. 4.

Modern mobile communication networks rely heavily on precise and secure location-based services to provide users with accurate positioning, navigation, and various location-dependent applications. A critical component in enabling these services is the SIM card, which can be enhanced to collect and transmit location data securely and efficiently. Users of mobile networks often require both real-time and historical location data for purposes such as navigation, tracking, emergency services, and business analytics.

Conventionally, the IP multimedia subsystem (IMS) network leverages location information corresponding to UEs to deliver multimedia communications services such as voice, video and text messaging over IP networks. Obtaining the precise location of the UEs is requires utilizing resources of the requestor making the request, the UEs, physical components of a mobile network operator (e.g., a base station), and the network itself (e.g., bandwidth). In many instances a precise location is not needed. However, the conventional IMS network is unable to acquire location in any other fashion.

In contrast to conventional solutions, the present disclosure provides an adhoc location-based service framework that exposes an application programming interface (API), allowing requestors to leverage location information already available within the network. For example, during Session Initiation Protocol (SIP) registration, location information (e.g., mobile country code (MCC), mobile network code (MNC), type allocation code (TAC), cell identifier (CELLID), sector identifier (SECTOR ID) is received by the Proxy Call Session Control Function (P-CSCF) of the node. The P-CSCF caches the device provided user location information. Moreover, UEs periodically (e.g., every hour) re-registers to a network so the location information is generally accurate.

In response to the request, the P-CSCF is queried for information corresponding to a UE. In some aspects, the P-CSCF invokes signaling to the Policy and Charging Rules Function (PCRF) and retrieves the network provided user location information (MCC, MNC, TAC, CELLID, SECTOR ID). In other aspects, the P-CSCF may maintain a mapping of users and locations to expedite the query response. Once retrieved, the information is provided to the requestor. Moreover, the information is provided without requiring the resources and bandwidth of conventional methods. In some aspects,

In some aspects, the information may be used by the requestor to confirm that a particular user corresponding to the UE is in a particular location. The request may manage access to one or more services provided by the requestor to a user account. In this example, the requestor may be a bank or other financial services provider and, for security purposes, may need to confirm the user is in the particular location (i.e., an expected location) before providing access to the user. In other aspects, the information is a list of users in a particular location. In this example, the requestor may desire to broadcast a message (e.g., an advertisement) to users in a particular location. The list of users can be utilized to communicate the broadcast message to the appropriate UEs.

Accordingly, a first aspect of the present disclosure provides a method for providing an adhoc location-based service framework. The method comprises receiving a request for information at an application programming interface (API) that enables a requestor to query a Proxy Call Session Control Function (P-CSCF). The method also comprises, in response to the request, querying the P-CSCF for information corresponding to a user device (UE). The method further comprises providing the information to the requestor.

In a second aspect of the present disclosure, a system for providing an adhoc location-based service framework is provided. The system comprises a node configured to wirelessly communicate with one or more user devices (UEs); the one or more UEs; a requestor providing one or more services via the node to the one or more UEs; and a location framework comprising an application programming interface (API). The API enables a requestor to query a Proxy Call Session Control Function (P-CSCF) of the node; in response to the request, queries the P-CSCF for information corresponding to the one or more UEs; and provides the information to the requestor.

Another aspect of the present disclosure is directed to one or more computer-readable media having computer-executable instructions embodied thereon that, when executed, perform a method for providing an adhoc location-based service framework. The method comprises receiving a request for information at an application programming interface (API) that enables a requestor to query a Proxy Call Session Control Function (P-CSCF). The method also comprises, in response to the request, querying the P-CSCF for information corresponding to a user device (UE). The method further comprises providing the information to the requestor.

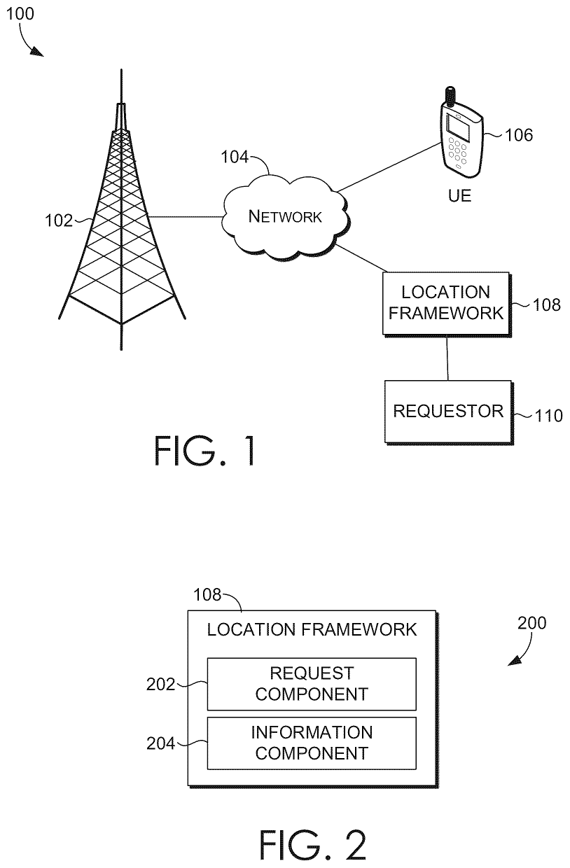

Turning to FIG. 1, a network environment suitable for use in implementing embodiments of the present disclosure is provided. Such a network environment is illustrated and designated generally as network environment 100. Network environment 100 is but one example of a suitable network environment and is not intended to suggest any limitation as to the scope of use or functionality of the disclosure. Neither should the network environment 100 be interpreted as having any dependency or requirement relating to any one or combination of components illustrated.

A network cell may comprise a base station to facilitate wireless communication between a communications device within the network cell, such as communications device 400 described with respect to FIG. 4, and a network. As shown in FIG. 1, a communications device may be a UE 106. In the network environment 100, UE 106 may communicate with other devices, such as mobile devices, servers, etc. The UE 106 may take on a variety of forms, such as a personal computer, a laptop computer, a tablet, a netbook, a mobile phone, a Smart phone, a personal digital assistant, or any other device capable of communicating with other devices. For example, the UE 106 may take on any form such as, for example, a mobile device or any other computing device capable of wirelessly communication with the other devices using a network. Makers of illustrative devices include, for example, Research in Motion, Creative Technologies Corp., Samsung, Apple Computer, and the like. A device can include, for example, a display(s), a power source(s) (e.g., a battery), a data store(s), a speaker(s), memory, a buffer(s), and the like. In embodiments, UE 106 comprises a wireless or mobile device with which a wireless telecommunication network(s) can be utilized for communication (e.g., voice and/or data communication). In this regard, the UE 106 can be any mobile computing device that communicates by way of, for example, a 5G network.

The UE 106 may utilize network 104 to communicate with other computing devices (e.g., mobile device(s), a server(s), a personal computer(s), etc.). In embodiments, network 104 is a telecommunications network, or a portion thereof. A telecommunications network might include an array of devices or components, some of which are not shown so as to not obscure more relevant aspects of the invention. Components such as terminals, links, and nodes (as well as other components) may provide connectivity in some embodiments. Network 104 may include multiple networks, as well as being a network of networks, but is shown in more simple form so as to not obscure other aspects of the present disclosure. Network 104 may be part of a telecommunications network that connects subscribers to their immediate service provider. In embodiments, network 104 is associated with a telecommunications provider that provides services to user devices, such as UE 106. For example, network 104 may provide voice services to user devices or corresponding users that are registered or subscribed to utilize the services provided by a telecommunications provider. It is contemplated network 104 can be any communication network providing voice and/or data service(s), such as, for example, a 1× circuit voice, a 3G network (e.g., CDMA, CDMA1000, WCDMA, GSM, UMTS), a 4G network (WiMAX, LTE, HSDPA), or the like.

The network environment 100 may include a database (not shown). The database may be similar to the memory component 412 in FIG. 4 and can be any type of medium that is capable of storing information. The database can be any collection of records (e.g., information including a list of user devices in a particular location). In one embodiment, the database includes a set of embodied computer-executable instructions that, when executed, facilitate various aspects disclosed herein. These embodied instructions will variously be referred to as “instructions” or an “application” for short.

As previously mentioned, the UE 106 may communicate with other devices by using a base station, such as base station 102. In embodiments, base station 102 is a wireless communications station that is installed at a fixed location, such as at a radio tower, as illustrated in FIG. 1. The radio tower may be a tall structure designed to support one or more antennas for telecommunications and/or broadcasting. In other embodiments, base station 102 is a mobile base station. The base station 102 may be an MMU and include gNodeB for mMIMO/5G communications via network 104. In this way, the base station 102 can facilitate wireless communication between UE 106 and network 104.

As stated, the base station 102 may include a radio (not shown) or a remote radio head (RRH) that generally communicates with one or more antennas associated with the base station 102. In this regard, the radio is used to transmit signals or data to an antenna associated with the base station 102 and receive signals or data from the antenna. Communications between the radio and the antenna can occur using any number of physical paths. A physical path, as used herein, refers to a path used for transmitting signals or data. As such, a physical path may be referred to as a radio frequency (RF) path, a coaxial cable path, cable path, or the like.

The antenna is used for telecommunications. Generally, the antenna may be an electrical device that converts electric power into radio waves and converts radio waves into electric power. The antenna is typically positioned at or near the top of the radio tower as illustrated in FIG. 1. Such an installation location, however, is not intended to limit the scope of embodiments of the present invention. The radio associated with the base station 102 may include at least one transceiver configured to receive and transmit signals or data.

Continuing, the network environment 100 may further include a location framework 108. The location framework 108 may be configured to, among other things, provide an adhoc location-based service framework, enabling a requestor 110 to query a P-CSCF for information, in accordance with the present disclosure. Though location framework 108 is illustrated as a standalone device (e.g., a server having one or more processors) in FIG. 1, it may be a component of base station 102, a service provided via the 5G network 104, or may be remotely located.

Referring now to FIG. 2, the location framework 108 may include, among other things, request component 202 and information component 204. The location framework 108 may receive, among other things, information from base station 102, such as data from a gNodeB or eNodeB or from a plurality of base stations, information from network 104, and/or a request from requestor 110.

Request component 202 generally exposes an API that enables a requestor to query a Proxy Call Session Control Function (P-CSCF) of the node. The information may be received by the P-CSCF during Session Initiation Protocol (SIP) registration. For example, UEs periodically (e.g., every hour) re-registers to a network. The P-CSCF caches the device provided user location information (e.g., mobile country code (MCC), mobile network code (MNC), type allocation code (TAC), cell identifier (CELLID), sector identifier (SECTOR ID). In response to the request, the P-CSCF invokes signaling to the PCRF/PCF and retrieves the network provided user location information (MCC, MNC, TAC, CELLID, SECTOR ID).

Information component 204 receives the information from P-CSCF and provides the information to the requestor. In practice, a requestor may manage access to one or more services provided by the requestor to a user account. For example, the requestor may be a bank or other financial services provider and, for security purposes, may need to confirm the UE is in the particular location (i.e., an expected location) before providing access to the user of the UE. In some aspects, by leveraging Artificial Intelligence (AI) and Machine Learning (ML) models, information component 204 may track the subscriber's daily location and use this data to identify location trends on an individual basis. Based on these learned location patterns, the AI and ML models may proactively offer location-based features and predict additional services that may benefit the user, tailored to their unique location trends.

Once the UE location is received and provided to the requestor, the requestor can provide or deny access accordingly. In another example, the requestor may desire to communicate a broadcast message (e.g., an advertisement) to users in a particular location. Once the list of UEs is received and provided to the requestor, the requestor may communicate the broadcast message to the users. In some aspects, the mobile network operator or a third party is provided the broadcast message and the list of users and communicates the broadcast message on behalf of the requestor.

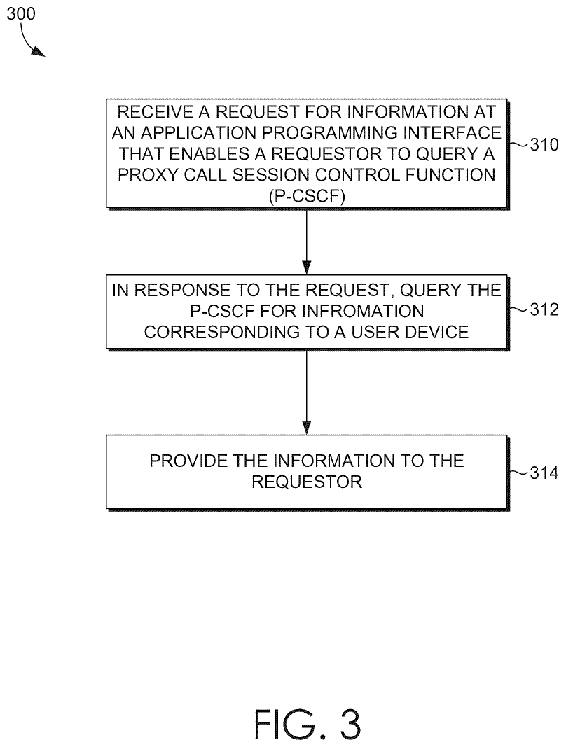

Referring to FIG. 3, a flow diagram is provided depicting a method for providing an adhoc location-based service framework, according to aspects of the technology described herein. Method 300 may be performed by any computing device (such as computing device described with respect to FIG. 4) with access to location framework (such as the one described with respect to FIGS. 1 and 2) or by one or more components of the network environment described with respect to FIG. 1 (such as UE 106, base station 102, or location framework 108). Initially, at step 310, a request is received for information at an application programming interface (API) that enables a requestor to query a Proxy Call Session Control Function (P-CSCF).

At step 312, in response to the request, the P-CSCF is queried for information corresponding to a user device (UE). In some aspects, the information is received by the P-CSCF during Session Initiation Protocol (SIP) registration. The P-CSCF may maintain a mapping of users and locations.

At step 314, the information is provided to the requestor. In some aspects, the information may be used by the requestor to confirm that a particular user corresponding to the UE is in a particular location. The request may manage access to one or more services provided by the requestor to a user account. In this example, the requestor may be a bank or other financial services provider and, for security purposes, may need to confirm the user is in the particular location (i.e., an expected location) before providing access to the user. In other aspects, the information is a list of users in a particular location. In this example, the requestor may desire to broadcast a message (e.g., an advertisement) to users in a particular location. The list of users can be utilized to communicate the broadcast message to the appropriate UEs.

Embodiments of the technology described herein may be embodied as, among other things, a method, a system, or a computer-program product. Accordingly, the embodiments may take the form of a hardware embodiment, or an embodiment combining software and hardware. The present technology may take the form of a computer-program product that includes computer-useable instructions embodied on one or more computer-readable media. The present technology may further be implemented as hard-coded into the mechanical design of network components and/or may be built into a broadcast cell or central server.

Computer-readable media includes both volatile and non-volatile, removable and non-removable media, and contemplate media readable by a database, a switch, and/or various other network devices. Network switches, routers, and related components are conventional in nature, as are methods of communicating with the same. By way of example, and not limitation, computer-readable media may comprise computer storage media and/or non-transitory communications media.

Computer storage media, or machine-readable media, may include media implemented in any method or technology for storing information. Examples of stored information include computer-useable instructions, data structures, program modules, and other data representations. Computer storage media may include, but are not limited to, RAM, ROM, EEPROM, flash memory or other memory technology, CD-ROM, digital versatile discs (DVD), holographic media or other optical disc storage, magnetic cassettes, magnetic tape, magnetic disk storage, and/or other magnetic storage devices. These memory components may store data momentarily, temporarily, and/or permanently, and are not limited to the examples provided.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

Referring to FIG. 4, a block diagram of an exemplary computing device 400 suitable for use in implementations of the technology described herein is provided. In particular, the exemplary computer environment is shown and designated generally as computing device 400. Computing device 400 is but one example of a suitable computing environment and is not intended to suggest any limitation as to the scope of use or functionality of the invention. Neither should computing device 400 be interpreted as having any dependency or requirement relating to any one or combination of components illustrated. It should be noted that although some components in FIG. 4 are shown in the singular, they may be plural. For example, the computing device 400 might include multiple processors or multiple radios. In aspects, the computing device 400 may be a UE/WCD, or other user device, capable of two-way wireless communications with an access point. Some non-limiting examples of the computing device 400 include a cell phone, tablet, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

As shown in FIG. 4, computing device 400 includes a bus 410 that directly or indirectly couples various components together, including memory 412, processor(s) 414, presentation component(s) 416 (if applicable), radio(s) 424, input/output (I/O) port(s) 418, input/output (I/O) component(s) 420, and power supply(s) 422. Although the components of FIG. 4 are shown with lines for the sake of clarity, in reality, delineating various components is not so clear, and metaphorically, the lines would more accurately be grey and fuzzy. For example, one may consider a presentation component such as a display device to be one of I/O components 420. Also, processors, such as one or more processors 414, have memory. The present disclosure hereof recognizes that such is the nature of the art, and reiterates that FIG. 4 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of the present disclosure and refer to “computer” or “computing device.”

Memory 412 may take the form of memory components described herein. Thus, further elaboration will not be provided here, but it should be noted that memory 412 may include any type of tangible medium that is capable of storing information, such as a database. A database may be any collection of records, data, and/or information. In one embodiment, memory 412 may include a set of embodied computer-executable instructions that, when executed, facilitate various functions or elements disclosed herein. These embodied instructions will variously be referred to as “instructions” or an “application” for short.

Processor 414 may actually be multiple processors that receive instructions and process them accordingly. Presentation component 416 may include a display, a speaker, and/or other components that may present information (e.g., a display, a screen, a lamp (LED), a graphical user interface (GUI), and/or even lighted keyboards) through visual, auditory, and/or other tactile cues.

Radio 524 represents a radio that facilitates communication with a wireless telecommunications network. Illustrative wireless telecommunications technologies include CDMA, GPRS, TDMA, GSM, and the like. Radio 524 might additionally or alternatively facilitate other types of wireless communications including Wi-Fi, WiMAX, LTE, 3G, 4G, LTE, mMIMO/5G, NR, VoLTE, or other VoIP communications. As can be appreciated, in various embodiments, radio 524 can be configured to support multiple technologies and/or multiple radios can be utilized to support multiple technologies. A wireless telecommunications network might include an array of devices, which are not shown so as to not obscure more relevant aspects of the invention. Components such as a base station, a communications tower, or even access points (as well as other components) can provide wireless connectivity in some embodiments.

The input/output (I/O) ports 518 may take a variety of forms. Exemplary I/O ports may include a USB jack, a stereo jack, an infrared port, a firewire port, other proprietary communications ports, and the like. Input/output (I/O) components 520 may comprise keyboards, microphones, speakers, touchscreens, and/or any other item usable to directly or indirectly input data into the computing device 500.

Power supply 522 may include batteries, fuel cells, and/or any other component that may act as a power source to supply power to the computing device 500 or to other network components, including through one or more electrical connections or couplings. Power supply 522 may be configured to selectively supply power to different components independently and/or concurrently.

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

What is claimed is:

1. A method for providing an adhoc location-based service framework, the method comprising:
receiving a request for information at an application programming interface (API) that enables a requestor to query a Proxy Call Session Control Function (P-CSCF);
in response to the request, querying the P-CSCF for information corresponding to a user device (UE); and
providing the information to the requestor.

2. The method of claim 1, wherein the information is received by the P-CSCF during Session Initiation Protocol (SIP) registration.

3. The method of claim 1, wherein the information is a confirmation that a particular user corresponding to the UE is in a particular location.

4. The method of claim 1, wherein the information is a list of users in a particular location.

5. The method of claim 1, wherein the P-CSCF maintains a mapping of users and locations.

6. The method of claim 1, wherein the requestor manages access to one or more services provided by the requestor to a user account.

7. The method of claim 1, wherein the requestor identifies users for communicating a broadcast message to the one or more UEs.

8. A system for providing an adhoc location-based service framework, the system comprising:
a node configured to wirelessly communicate with one or more user devices (UEs);
the one or more UEs;
a requestor providing one or more services via the node to the one or more UEs; and
a location framework comprising an application programming interface (API) that:
enables a requestor to query a Proxy Call Session Control Function (P-CSCF) of the node;
in response to the request, queries the P-CSCF for information corresponding to the one or more UEs; and
provides the information to the requestor.

9. The system of claim 8, wherein the information is received by the P-CSCF during Session Initiation Protocol (SIP) registration.

10. The system of claim 8, wherein the information is a confirmation that a particular user corresponding to a UE of the one or more UEs is in a particular location.

11. The system of claim 8, wherein the information is a list of users in a particular location.

12. The system of claim 8, wherein the P-CSCF maintains a mapping of users and locations.

13. The system of claim 8, wherein the requestor manages access to the one or more services for a user account.

14. The system of claim 8, wherein the requestor identifies users for communicating a broadcast message to the one or more UEs.

15. One or more computer-readable media having computer-executable instructions embodied thereon that, when executed, perform a method for providing an adhoc location-based service framework, the method comprising:
receiving a request for information at an application programming interface (API) that enables a requestor to query a Proxy Call Session Control Function (P-CSCF);
in response to the request, querying the P-CSCF for information corresponding to a user device (UE); and
providing the information to the requestor.

16. The media of claim 15, wherein the information is received by the P-CSCF during Session Initiation Protocol (SIP) registration.

17. The media of claim 15, wherein the information is a confirmation that a particular user corresponding to the UE is in a particular location or a list of users in a particular location.

18. The media of claim 15, wherein the P-CSCF maintains a mapping of users and locations.

19. The media of claim 15, wherein the requestor manages access to one or more services provided by the requestor to a user account.

20. The media of claim 15, wherein the requestor identifies users for communicating a broadcast message to the one or more UEs.
